(19) United States
(12) Patent Application Publication
(10) Pub. No.: US 2024/0305604 A1
(43) Pub. Date: Sep. 12, 2024

(54) METHODS AND APPARATUS TO ORCHESTRATE INTERNET PROTOCOL ADDRESS MANAGEMENT

(71) Applicant: VMware LLC, Palo Alto, CA (US)

(72) Inventors: Marin Stoyanov Dzhigarov, Lozen (BG); Nikola Zdravkov Bratanov, Sofia (BG); Stoyan Staykov Genchev, Sofia (BG); Plamen Veselinov Peev, Troyan (BG); Kristina Angelova Zhelyazkova, Sofia (BG)

(21) Appl. No.: 18/182,121

(22) Filed: Mar. 10, 2023

(51) Int. Cl. H04L 61/5007; H04L 41/02

(52) U.S. Cl. CPC H04L 61/5007; H04L 41/02

(57) ABSTRACT

An example system includes at least one memory; programmable circuitry; and machine-readable instructions to program the programmable circuitry to: select an orchestration integration based on capability tags of a plurality of orchestration integrations and based on constraints of an internet protocol address management (IPAM) integration; and cause execution of a workflow using the orchestration integration, the workflow to cause an IPAM system to allocate an internet protocol address for a resource of a cloud application.

### FIELD OF THE DISCLOSURE

This disclosure relates generally to internet protocol address management and, more particularly, to methods and apparatus to orchestrate internet protocol address management.

### BACKGROUND

Cloud environments are sometimes used to execute workloads. Such workloads can be executed using cloud applications. Cloud applications are a collection of compute resources that are coupled by a cloud network. Compute resources are virtual computer systems that are capable of providing computing services. Compute resources are accessible and identifiable by an address. Address management systems reduce complexity in allocating internet protocol addresses for compute resources of cloud applications.

### BRIEF DESCRIPTION OF THE DRAWINGS

FIG. 1 is a prior timing diagram of operations of a cloud automation tool to manage internet protocol addresses using an external internet protocol address management system in accordance with prior techniques.

FIG. 2 is a block diagram of an example cloud network including an example cloud automation tool, configured to use to a gateway to cause a server to orchestrate internet protocol address management using external internet protocol address management systems.

FIG. 3 is a schematic illustration of the example cloud automation tool of FIG. 2.

FIG. 4 is a schematic illustration of the example gateway of FIG. 2.

FIG. 5 is a schematic illustration of the example server of FIG. 2.

FIGS. 6A and 6B are a timing diagram of example operations of the cloud automation tool of FIGS. 2 and 3, the gateway of FIGS. 2 and 4, and the server of FIGS. 2 and 5 to manage internet protocol addresses using an external internet protocol address management system.

FIG. 7 is a flowchart representative of example machine-readable instructions and/or example operations that may be executed by example processor circuitry to implement the cloud automation tool of FIGS. 2 and 3.

FIG. 8 is a flowchart representative of example machine-readable instructions and/or example operations that may be executed by example processor circuitry to implement the gateway of FIGS. 2 and 4.

FIG. 9 is a flowchart representative of example machine-readable instructions and/or example operations that may be executed by example processor circuitry to implement the server of FIGS. 2 and 5.

FIG. 10 is a block diagram of an example processing platform including processor circuitry structured to execute the example machine-readable instructions and/or the example operations of FIG. 3 to implement the cloud automation tool of FIGS. 2 and 3, the gateway of FIGS. 2 and 4, and the cloud automation tool of FIGS. 2 and 5.

FIG. 11 is a block diagram of an example implementation of the processor circuitry of FIG. 10.

FIG. 12 is a block diagram of another example implementation of the processor circuitry of FIG. 10.

FIG. 13 is a block diagram of an example software distribution platform (e.g., one or more servers) to distribute software (e.g., software corresponding to the example machine-readable instructions of FIGS. 7-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to being within one second of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

As cloud computing technologies advance, development of cloud services have become common. Cloud computing, typically, utilizes computing services that are capable of processing substantially more than what may be needed to implement cloud services. For example, a cloud service may be deployed as part of a data center that includes server racks each including a plurality of instances of programmable circuitry. In other examples, a cloud application may be deployed on a local network that supports computing operations for a plurality of cloud applications. With demands for cloud computing increasing, incentives for automating orchestration of computing resources increase.

Cloud computing occurs in response to a deployment of physical resources across a network, virtualizing the physical resources into virtual resources, and provisioning the virtual resources for use across cloud virtual machines, computing services, and/or applications. Cloud automation services reduce creation and deployment complexity of virtual machines, computing services, and applications in a given cloud computing infrastructure. Some such cloud automation services, such as VMware's vRealize Automation (vRA) cloud assembly tool, automate deployment, orchestration, governance, extensibility, and management of resources in a cloud infrastructure. As complexity of cloud applications continues to increase, processes of cloud automation tools have become increasingly complex.

Some cloud applications use external systems to reduce management complexity. Integrating and automating usage of such external systems further complicates cloud automation tools processes.

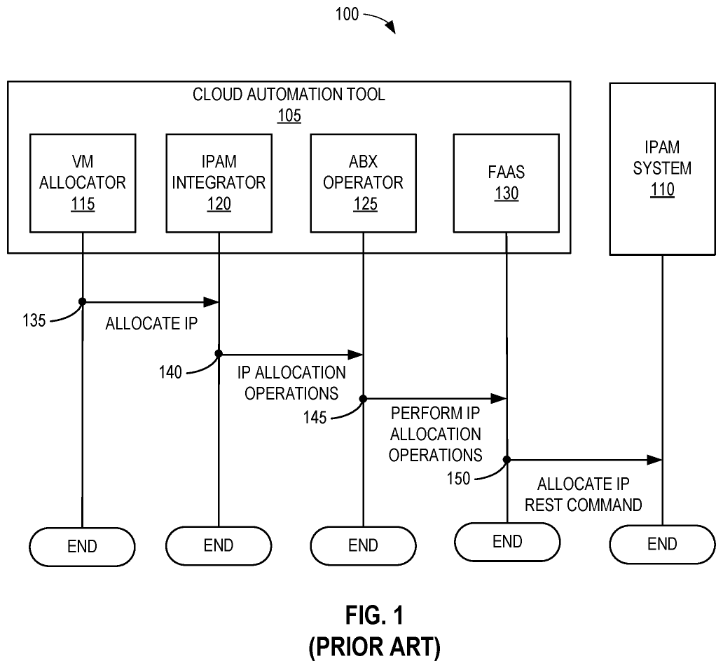

FIG. 1 is a prior timing diagram of operations 100 of a cloud automation tool 105 configured to manage internet protocol addresses using an internet protocol address management (IPAM) system 110 in accordance with a prior technique. In FIG. 1, the operations 100 cause the IPAM system 110, which is an external system, to allocate an IP address.

The cloud automation tool 105 includes a virtual machine (VM) allocator 115, an IPAM integrator 120, an action-based extensibility (ABX) operator 125, and a function-as-a-service (FaaS) 130. The cloud automation tool 105 deploys and orchestrates operations of cloud applications. The IPAM system 110 is an external system outside the cloud automation tool 105 and is configured to manage IP addresses of cloud applications of the cloud automation tool 105.

At a first time 135, the VM allocator 115 supplies an IP address of a virtual machine (not illustrated) to the IPAM integrator 120. The virtual machine is a resource of a cloud application that the cloud automation tool 105 manages. At the first time 135, the VM allocator 115 begins a process of allocating the IP address of the virtual machine.

At a second time 140, the IPAM integrator 120 identifies allocation operations in the ABX operator 125. The allocation operations cause allocation of the IP address, from the first time 135.

At a third time 145, the ABX operator 125 executes the allocation operations using the FaaS 130. At the third time 145, the FaaS 130 generates allocation commands based on the allocation operations.

At a fourth time 150, the FaaS 130 supplies the allocation commands to the IPAM system 110. The allocation commands cause the IPAM system 110 to allocate the IP address from the first time 135. However, such management of IP addresses results in excessive interfacing between the cloud automation tool 105 and the IPAM system 110.

Examples disclosed herein include methods and apparatus to orchestrate internet protocol address management. In some disclosed examples, a cloud automation tool uses compute resources of a cloud network to orchestrate operations of external management systems. The disclosed cloud network includes the cloud automation tool, a gateway, and a plurality of orchestration integrations. The cloud automation tool generates integration information. The integration information including constraints defined by a cloud application and constraints defined by the cloud automation tool. The gateway selects one of the orchestration integrations to execute integration workflows based on the integration information. The gateway causes the one of the orchestration integrations to perform operations of an integration workflow. The integration workflow to cause an external IPAM system to perform a corresponding operation.

The integration information allows the gateway to accurately identify orchestration integrations that are capable of interfacing with an external IPAM system. Additionally, causing execution of integration workflows in an orchestration integration decreases complexity of cloud automation tools which use external management systems.

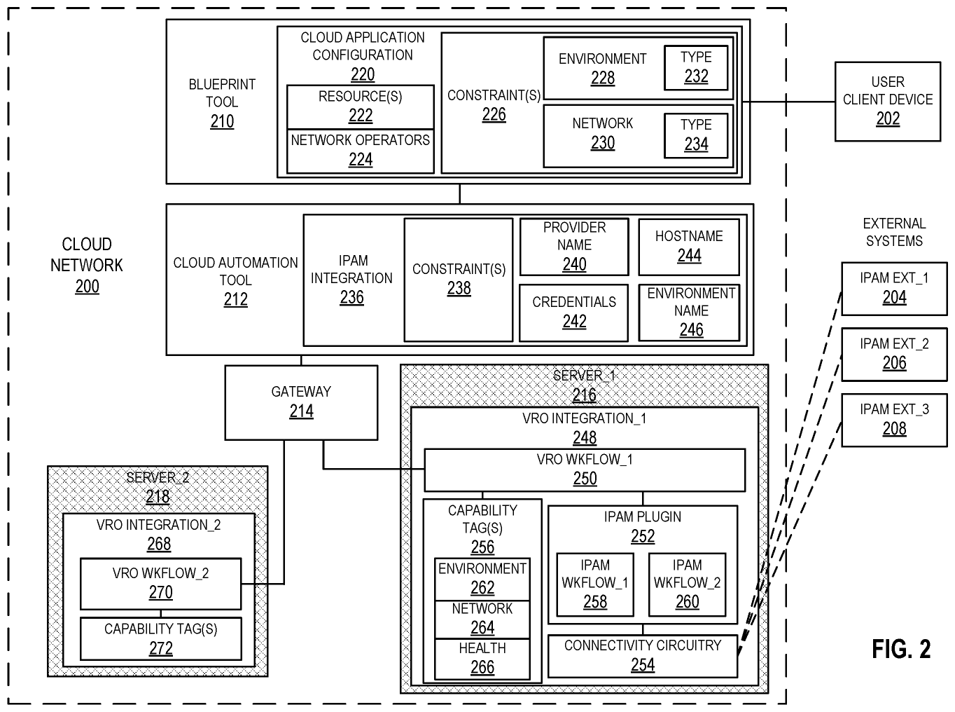

FIG. 2 is a block diagram of an example cloud network 200 configured in communication with an example user client device 202, a first example management system 204, a second example management system 206, and a third example management system 208. The example cloud network 200 interfaces with the user client device 202 and the management systems 204-208. In some examples, the cloud network 200 allows the user client device 202 to develop and deploy cloud applications which use one or more of the management systems 204-208. In some examples, the management systems 204-208 are IPAM systems configured to manage IP addresses, such as Infoblox, Efficient IP, and Bluecat. In such examples, the management systems 204-208 manage IP addresses of cloud applications, such as allocation of IP addresses, deallocation of IP addresses, acquiring a range of IP addresses, etc. Accordingly, the management systems 204-208 may be described, referred to, and/or illustrated as external systems.

In the example of FIG. 2, the cloud network 200 includes an example blueprint tool 210, an example cloud automation tool 212, an example gateway 214, a first example server 216, and a second example server 218. The example cloud network 200 represents tools and services that allow the user client device 202 to develop and deploy a cloud application that uses one or more of the management systems 204-208.

The example blueprint tool 210 in communication with the user client device 202 and the cloud automation tool 212. In the example of FIG. 2, the blueprint tool 210 includes an example cloud application configuration 220. The example blueprint tool 210 is a graphical user interface (GUI). The example blueprint tool 210 receives input from the user client device 202. The example blueprint tool 210 allows the user client device 202 to create the cloud application configuration 220 using relatively high-level visual abstractions of functions of cloud services. For example, the user client device 202 may create a cloud application by creating a block diagram. In such an example, the blueprint tool 210 generates the cloud application configuration 220 to represent the cloud application. The example blueprint tool 210 supplies the cloud application configuration 220 to the cloud automation tool 212 for deployment.

The example cloud application configuration 220 represents a design of a cloud application. In the example of FIG. 2, the cloud application configuration 220 includes configuration information that represent example resources 222, example network operators 224, and first example constraints 226. The example cloud automation tool 212 deploys the cloud application configuration 220 to create a cloud application.

The example resources 222 represent virtual computer systems that provide computing services. In some examples, the resources 222 identify a physical amount of computing services to allocate. In such examples, the physical computing resources construct a virtual computing resource, such as a virtual machine. In other examples, the resources 222 identify a type of computing service to allocate, such as graphical processing unit (GPU), central processing unit (CPU), etc.

The example network operators 224 represent operations to orchestrate and/or manage the resources 222. For example, the network operators 224 may include a load balancer configured to orchestrate communications of the resources 222. In some examples, the network operators 224 may monitor allocation of computing resources to the resources 222. In other examples, the network operators 224 may monitor operations of the resources 222.

The first example constraints 226 specify limitations of and/or preferences for orchestration of the cloud application configuration 220. In the example of FIG. 2, the first constraints 226 include an example environment constraint 228 and an example network constraint 230. The first example constraints 226 are user definable fields that are specific to the cloud application configuration 220. In some examples, the first constraints 226 may limit orchestration operations to occur in certain environments or networks. In other examples, the first constraints 226 may indicate a preference for orchestration operations to occur in certain environments or networks.

The example environment constraint 228 represents limitations on or preferences of environments in which orchestration operations are to occur. In some examples, the environment constraint 228 identifies an off-premises execution environment, such as Amazon Web Services (AWS), Azure, etc. In other examples, the environment constraint 228 identifies an on-premises execution environment, such as an extensibility integration local to an orchestration integration. For example, a server performing orchestration operations of a cloud application may allocate a portion of computing services to perform extensibility operations.

As used herein, an orchestration integration is a collection of virtual computing resources configured to perform workflows. Orchestration integrations are configurable to preform workflows which automate operations of a deployed cloud application. In some examples, the user client device 202 develops and/or selects workflows to perform operations using the compute resources of the orchestration integration. For example, an orchestration integration includes workflows which, when performed by the computing resources of the orchestration integration, causes operations in third-party tools, such as management systems 204-208. In such examples, workflows may be scripts, machine-readable instructions, etc.

Orchestration integrations are established and managed by an orchestrator service. Some such orchestrator services, such as VMware's vRealize Automation Orchestrator (vRO) tool, orchestrates deployment of orchestration integrations, manages performance of workflows, and updates workflows in orchestration integrations. Orchestration integrations expand automation capabilities of cloud automation services, such as the cloud automation tool 212. In some examples, the cloud automation tool 212 may cause an orchestration integration to execute a workflow to use third-party tools, infrastructure, and/or applications. In other examples, the cloud automation tool 212 may cause an orchestration integration to execute a workflow to apply operation software suites, such as DevOps and agile, to accelerate workflow development. Such workflows may be used to automate Day two operations of cloud applications, such as continuing management operations, services, IP address allocations, etc.

In the example of FIG. 2, the environment constraint 228 includes a first example type identifier 232. The first example type identifier 232 identifies whether the environment constraint 228 is a limitation or a preference. In some examples, the first type identifier 232 defines the environment constraint 228 as a hard-type. In such examples, the environment constraint 228 is a limitation on which environments may be used for orchestration operations. In other examples, the first type identifier 232 defines the environment constraint 228 as a soft-type. In such examples, the environment constraint 228 is a preference of which environments are preferred for orchestration operations.

The example network constraint 230 represents a limitation on or a preference of networks in which orchestration operations are to occur. In some examples, the network constraint 230 identifies relatively high-speed networks. In other examples, the network constraint 230 identifies relatively low-speed networks.

In the example of FIG. 2, the network constraint 230 includes a second example type identifier 234. The second example type identifier 234 identifies whether the network constraint 230 is a limitation or a preference. In some examples, the second type identifier 234 defines the network constraint 230 as a hard-type. In such examples, the network constraint 230 is a limitation on which networks may be used for orchestration operations. In other examples, the second type identifier 234 defines the network constraint 230 as soft-type. In such examples, the network constraint 230 is a preference of which networks are preferred for orchestration operations.

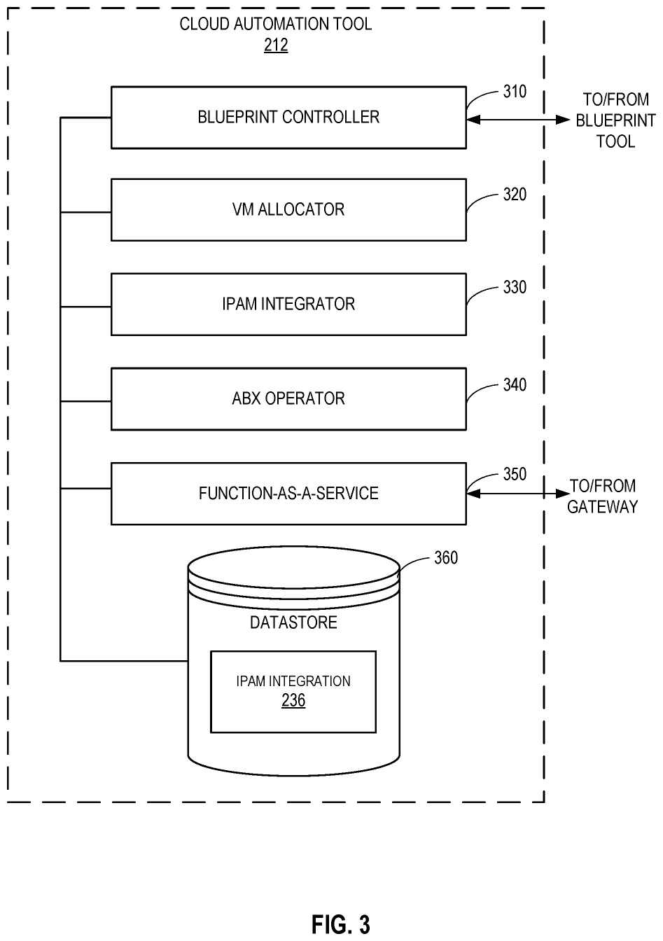

The example cloud automation tool 212 is coupled to the blueprint tool 210 and the gateway 214. The example cloud automation tool 212 receives the cloud application configuration 220 from the blueprint tool 210. The example cloud automation tool 212 allocates cloud computing resources to deploy the cloud application configuration 220. In the example of FIG. 2, the cloud automation tool 212 includes an example IPAM integration 236. The example cloud automation tool 212 generates IPAM integration information based on the first constraints 226 and the IPAM integration 236. The example cloud automation tool 212 supplies the IPAM integration information to the gateway 214. An example of the cloud automation tool 212 is illustrated and discussed in FIG. 3, below.

The example IPAM integration 236 is an integration specific to one of the management systems 204-208. In the example of FIG. 2, the IPAM integration 236 includes configuration information that represents second example constraints 238, an example provider name 240, example credentials 242, an example hostname 244, and an example running environment name 246. The example IPAM integration 236 identifies which of the management systems 204-208 is to be integrated with orchestration operations of the cloud application configuration 220.

The second example constraints 238 specify limitations and preferences for orchestration of the cloud application configuration 220. In some examples, the IPAM integration 236 combines the constraints 226 and 238 to limit orchestration operations to occur in certain environments or networks. In other examples, the IPAM integration 236 combines the constraints 226 and 238 to indicate preferences for orchestration operations. Similar to the first constraints 226, the second example constraints 238 may include a plurality of limitations and/or preferences for orchestration of the cloud application configuration 220.

The example provider name 240 identifies a management suite of at least one of the management systems 204-208. In some examples, the provider name 240 corresponds to a plurality of operations that, when performed, cause corresponding operations in the at least one of the management systems 204-208. In such examples, the plurality of operations may be integrated into one or more of the servers 216 and/or 218. For example, the cloud automation tool 212 may supply the plurality of management system specific operations to the first server 216. In such examples, the first server 216 stores the operations as workflows identifiable by the provider name 240 and/or operations of the provider name 240.

The example credentials 242 identify an account in one of the management systems 204-208. In some examples, the user client device 202 supplies the credentials 242 to the cloud automation tool 212 via the blueprint tool 210. In such examples, the user client device 202 acquires the credentials 242 by establishing the account in the one of the management systems 204-208. The example management systems 204-208 may need the credentials 242 prior to performing orchestration operations. In some examples, the management systems 204-208 may charge the account identified by the credentials 242 for computing services and/or access to management suits.

The example hostname 244 identifies a network location and/or a specific compute device that hosts operations of at least one of the management systems 204-208. In some examples, the hostname 244 identifies a server that offers at least one of the management systems 204-208 as a service. In other examples, the hostname 244 identifies a computing device that integrates at least one of the management systems 204-208.

The example environment name 246 specifies an execution environment of at least one of the management systems 204-208. In some examples, the environment name 246 identifies execution environments capable of integrating with the one of the management systems 204-208, identified by the provider name 240. In other examples, the environment name 246 identifies an execution service capable of performing operations specific to one of the management services 204-208. For example, a first execution environment may be capable of executing python scripts, while a second execution environment may only be capable of executing java scripts.

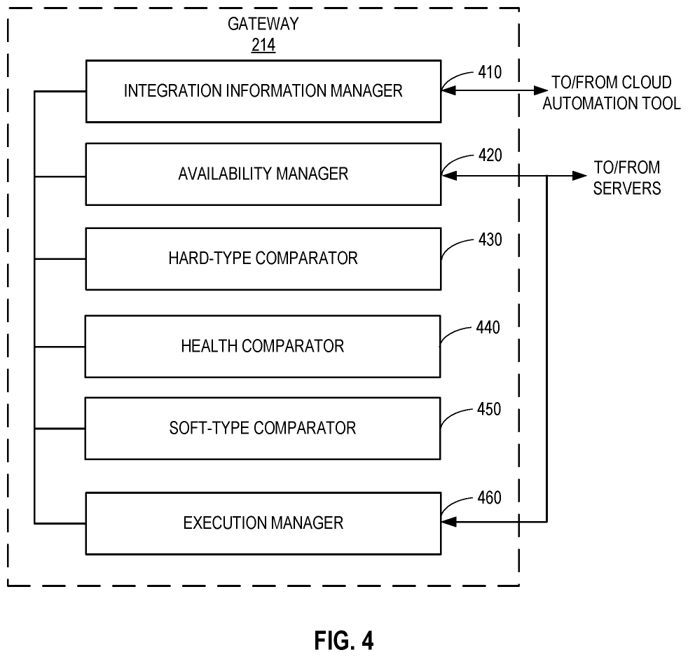

The example gateway 214 is in communication with the cloud automation tool 212 and the servers 216 and 218. The example gateway 214 receives IPAM integration information from the cloud automation tool 212. The example gateway 214 selects one of the servers 216 or 218 based on the integration information. The example gateway 214 causes execution of a workflow in the selected server. In some examples, the workflow orchestrates operations between the cloud network 200 and the management systems 204-208. An example of the gateway 214 is illustrated and discussed in FIG. 4, below.

The first example server 216 is in communication with the management services 204-208 and the gateway 214. The first example server 216 receives execution information from the gateway 214. The execution information causes the first example server 216 to perform operations of a workflow. Such a performance of operations may be referred to as a process of executing the workflow. In some examples, the first server 216 generates commands specific to one of the management systems 204-208 in response to the execution information. In such examples, the first server 216 supplies the commands to the one of the management systems 204-208 to cause performance of orchestration operations.

The first example server 216 may include a plurality of computing services. In the example of FIG. 2, the first server 216 includes a first example orchestration integration 248. The first example orchestration integration 248 is a portion of the computing services of the first server 216. The first example orchestration integration 248 uses computing services to perform orchestration operations of a deployment of the cloud application configuration 220. In example FIG. 2, the first example orchestration integration 248 is implemented using vRO developed by VMWare, Inc. of the United States of America. However, any other suitable type of orchestrator may be used.

The first example orchestration integration 248 is in communication with the cloud automation tool 212 by the gateway 214. In the example of FIG. 2, the first orchestration integration 248 includes a first example orchestration workflow 250, an example IPAM plugin 252, example connectivity circuitry 254, and first example capability tags 256. In some examples, the first orchestration integration 248 is configurable, by the gateway 214 to execute orchestration operations of the first orchestration workflow 250.

The first example orchestration workflow 250 is in communication with the gateway 214, the IPAM plugin 252, and the capability tags 256. The first example orchestration workflow 250 is a plurality of operations that, when performed by computing services of the first example server 216, orchestrate a deployment of the cloud application configuration 220. The first example orchestration workflow 250 receives execution information from the gateway 214. In some examples, the first orchestration workflow 250 uses the IPAM plugin 252 to perform orchestration operations using at least one of the management systems 204-208. The first example orchestration workflow 250 supplies the capability tags 256 to the gateway 214.

The example IPAM plugin 252 is in circuit with the first orchestration workflow 250 and the connectivity circuitry 254. In the example of FIG. 2, the IPAM plugin 252 includes a first IPAM workflow 258 and a second IPAM workflow 260. Alternatively, the example IPAM plugin 252 may be modified, in accordance with the teachings disclosed herein, to include any plurality of IPAM workflows. The example IPAM plugin 252 performs operations of one of the IPAM workflows 258 or 260, using compute services of the first server 216, based on the first orchestration workflow 250. In some examples, the first orchestration workflow 250 identifies one of the IPAM workflows 258 or 260 based on execution information from the gateway 214. The example IPAM plugin 252 generates commands by performing at least one of the IPAM workflows 258 or 260. The example IPAM plugin 252 supplies the commands to the connectivity circuitry 254.

The first example IPAM workflow 258 includes a plurality of operations that cause generation of commands to cause a corresponding operation in one of the management systems 204-208. The first example IPAM workflow 258 is identifiable by the corresponding operation and/or the one of the management systems 204-208. In some examples, the first orchestration workflow 250 causes execution of the first IPAM workflow 258 to perform the corresponding operation. In such examples, the first IPAM workflow 258 results in generation of one or more commands, specific to the one of the management systems 204-208.

The second example IPAM workflow 260 includes a plurality of operations that cause generation of commands to cause a corresponding operation in one of the management systems 204-208. The second example IPAM workflow 260 is identifiable by the corresponding operation and/or the one of the management systems 204-208. In some examples, the first orchestration workflow 250 causes execution of the second IPAM workflow 260 to perform the corresponding operation. In such examples, the second IPAM workflow 260 results in generation of one or more commands, specific to the one of the management systems 204-208.

The example connectivity circuitry 254 is in communication with the management systems 204-208 and the IPAM plugin 252. The example connectivity circuitry 254 receives commands from the IPAM plugin 252. The connectivity circuitry 254 supplies the commands to one of the management systems 204-208. In some examples, the IPAM plugin 252 identifies the one of the management systems 204-208. In other examples, the connectivity circuitry 254 identifies the one of the management systems 204-208 based on the commands from the IPAM plugin 252. The example connectivity circuitry 254 sends the one or more commands to the one of the management systems 204-208 identified by the IPAM integration 236.

The first example capability tags 256 are in circuit with the first orchestration workflow 250. The first example capability tags 256 represent properties of the first orchestration integration 248. In the example of FIG. 2, the first capability tags 256 include an example environment tag 262, an example network tag 264, and an example health tag 266. In some examples, the first orchestration integration 248 generates the first capability tags 256 as part of an installation on the first server 216. In such examples, the first capability tags 256 are updated during an update to the first orchestration integration 248.

The example environment tag 262 represents an execution environment of the first orchestration integration 248. In some examples, the execution environment may be locally hosted, such as on premises (onPrem). In other examples, the execution environment may be hosted by remote computing services.

The example network tag 264 represents a type of network of the first orchestration integration 248. In some examples, the network tag 264 specifies a speed of the network of the first orchestration integration 248. In such examples, the network tag 264 may indicate a relatively high-speed network or a relatively low-speed network. In other examples, the network tag 264 specifies a type of the network of the first orchestration integration 248.

The example health tag 266 represents a version of the first orchestration integration 248 and/or a version of the IPAM plugin 252. The version identified by the example health tag 266 determines whether the gateway 214 may implement soft-types (e.g., the type identifiers 232 and 234) of the constraints 226 and/or 238. In some examples, the gateway 214 determines whether the first orchestration integration 248 is in a healthy state based on a comparison of the health tag 266 to IPAM integration information. In such examples, the gateway 214 determines a healthy state when the health tag 266 represents an up-to-date version of the IPAM plugin 252 and an unhealthy state when the health tag 266 represents an out-of-date version of the IPAM plugin 252.

The second example server 218 is in communication with the gateway 214. The second example server 218 receives execution information from the gateway 214. The execution information causes the second example server 218 to perform operations of a workflow. The second example server 218 may include a plurality of computing services. In the example of FIG. 2, the second server 218 includes a second example orchestration integration 268. The second example orchestration integration 268 is a portion of the computing services of the second server 218. The second example orchestration integration 268 uses computing services to perform orchestration operations of a deployment of the cloud application configuration 220. In example FIG. 2, the second example orchestration integration 268 may be implemented using vRealize automation orchestrator (vRO) developed by VMWare, Inc. However, any other suitable orchestration integration may be used.

The second example orchestration integration 268 is in communication with the cloud automation tool 212 via the gateway 214. In the example of FIG. 2, the second orchestration integration 268 includes a second example orchestration workflow 270 and second example capability tags 272. In some examples, the second orchestration integration 268 is configurable, by the gateway 214 to execute orchestration operations of the second orchestration workflow 270.

The second example orchestration workflow 270 is in communication with the gateway 214 and the second capability tags 272. The second example orchestration workflow 270 includes a plurality of operations that, when performed by computing services of the second server 218, orchestrate a deployment of the cloud application configuration 220. The second example orchestration workflow 270 receives execution information from the gateway 214. In some examples, the second orchestration workflow 270 performs orchestration operations. The second example orchestration workflow 270 supplies the second capability tags 272 to the gateway 214.

The second example capability tags 272 are in circuit with the second orchestration workflow 270. The second example capability tags 272 represent properties of the second orchestration integration 268. In some examples, the first orchestration integration 248 generates the second capability tags 272 as part of an installation on the second server 218. In such examples, the second capability tags 272 are updated during an update to the second orchestration integration 268.

FIG. 3 is a block diagram of the example cloud automation tool 212 of FIG. 2 to orchestrate management of a deployment of the cloud application configuration 220 of FIG. 2 using one of the orchestration integrations 248 or 268 of FIG. 2. The example cloud automation tool 212 of FIG. 3 may be instantiated (e.g., creating an instance of, bring into being for any length of time, materialize, implement, etc.) by processor circuitry such as a central processing unit executing instructions. Additionally or alternatively, the example cloud automation tool 212 of FIG. 3 may be instantiated (e.g., creating an instance of, bring into being for any length of time, materialize, implement, etc.) by an ASIC or an FPGA structured to perform operations corresponding to the instructions. It should be understood that some or all of the example cloud automation tool circuitry 212 of FIG. 3 may, thus, be instantiated at the same or different times. Some or all of the example cloud automation tool circuitry 212 may be instantiated, for example, in one or more threads executing concurrently on hardware and/or in series on hardware. Moreover, in some examples, some or all of the example cloud automation tool circuitry 212 of FIG. 3 may be implemented by microprocessor circuitry executing instructions to implement one or more virtual machines and/or containers.

In the example of FIG. 3, the cloud automation tool 212 includes an example blueprint controller 310, an example VM allocator 320, an example IPAM integrator 330, an example ABX operator 340, an example function-as-a-service (FaaS) 350, and an example datastore 360.

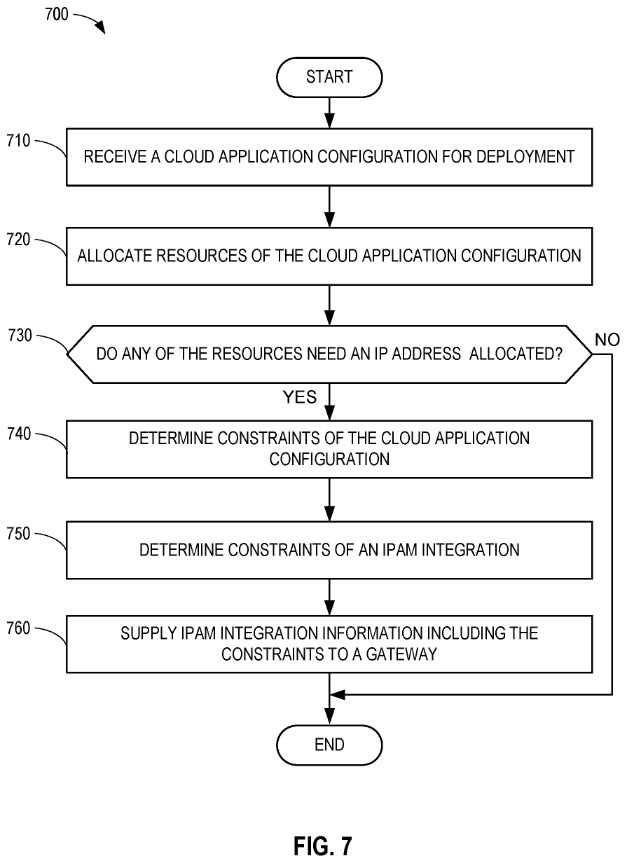

The example blueprint controller 310 receives the cloud application configuration 220 from the blueprint tool 210 of FIG. 2. In some examples, the blueprint tool 210 supplies the cloud application configuration 220 to the blueprint controller 310. The example blueprint controller 310 supplies the resources 222 of FIG. 2 to the VM allocator 320 for deployment. In some examples, the blueprint controller circuitry 310 is instantiated by processor circuitry executing blueprint controller instructions and/or configured to perform operations such as those represented by the flowchart of FIG. 7.

The example VM allocator 320 receives the resources 222 from the blueprint controller 310. The example VM allocator 320 deploys the resources 222. In some examples, the VM allocator 320 allocates physical computing services to create a virtual computing resources that represents one or more of the resources 222. In such examples, the virtual computing resources may be a virtual machine. The example VM allocator 320 supplies an IP address of the deployed resource to the IPAM integrator 330 to allocate the IP address to the deployed resource. In some examples, the VM allocator circuitry 320 is instantiated by processor circuitry executing VM allocator instructions and/or configured to perform operations such as those represented by the flowchart of FIG. 7.

The example IPAM integrator 330 receives IP addresses from the VM allocator 320. The IPAM integrator 330 identifies the IPAM integration 236 of FIG. 2. The example IPAM integrator 330 causes the ABX operator 340 to perform operations that cause an orchestration integration to use one of the management systems 204-208 for orchestration operations. The example IPAM integration 236 identifies information, such as the provider name 240 of FIG. 2, the credentials 242 of FIG. 2, the hostname 244 of FIG. 2, and/or the environment name 246 of FIG. 2, of the one of the management systems 204-208. In some examples, the IPAM integrator circuitry 330 is instantiated by processor circuitry executing IPAM integrator instructions and/or configured to perform operations such as those represented by the flowchart of FIG. 7.

The example ABX operator 340 receives information specific to the IPAM integration 236 from the IPAM integrator 330. The example ABX operator 340 executes operations identified by the IPAM integrator 330 using the FaaS 350. In some examples, the ABX operator circuitry 340 is instantiated by processor circuitry executing ABX operator instructions and/or configured to perform operations such as those represented by the flowchart of FIG. 7.

The example FaaS 350 performs operations of the ABX operator 340. The example FaaS 350 generates integration information based on information from the ABX operator 340. In some examples, the integration information includes an IP address to be allocated, the provider name 240, the credentials 242, the hostname 244, and/or the environment name 246. The example FaaS 350 supplies the integration information to the gateway 214 of FIG. 2. The example FaaS 350 causes the gateway 214 to select an orchestration integration (e.g., the orchestration integrations 240 and 268) to perform orchestration operations using one of the management systems 204-208. In some examples, the FaaS circuitry 350 is instantiated by processor circuitry executing FaaS instructions and/or configured to perform operations such as those represented by the flowchart of FIG. 7.

The example datastore 360 stores information of the IPAM integration 236. The example IPAM integration 236 includes information to allow an orchestration integration to use at least one of the management systems 204-208.

FIG. 4 is a block diagram of the example gateway 214 of FIG. 2 to select and cause execution of an orchestration workflow that uses one of the management systems 204-208. The example gateway 214 of FIG. 4 may be instantiated (e.g., creating an instance of, bring into being for any length of time, materialize, implement, etc.) by processor circuitry such as a central processing unit executing instructions. Additionally or alternatively, the example gateway 214 of FIG. 4 may be instantiated (e.g., creating an instance of, bring into being for any length of time, materialize, implement, etc.) by an ASIC or an FPGA structured to perform operations corresponding to the instructions. It should be understood that some or all of the gateway circuitry 214 of FIG. 4 may, thus, be instantiated at the same or different times. Some or all of the gateway circuitry 214 may be instantiated, for example, in one or more threads executing concurrently on hardware and/or in series on hardware. Moreover, in some examples, some or all of the gateway circuitry 214 of FIG. 4 may be implemented by microprocessor circuitry executing instructions to implement one or more virtual machines and/or containers.

In the example of FIG. 4, the gateway 214 includes an example integration information manager 410, an example availability manager 420, an example hard-type comparator 430, an example health comparator 440, an example soft-type comparator 450, and an example execution manager 460.

The example integration information manager 410 receives integration information from the cloud automation tool 212 of FIGS. 2 and 3. The example integration information manager 410 determines type identifiers (e.g., the type identifiers 232 and 234 of FIG. 2) corresponding to constraints (e.g., the constraints 226 and 238) of the integration information. In some examples, the type identifiers may identify a constraint as a hard-type or a soft-type. The example integration information manager 410 supplies hard-type constraints to the hard-type comparator 430. The example integration information manager 410 supplies soft-type constraints to the soft-type comparator 450. The example integration information manager 410 supplies management system specific information, such as the provider name 240 of FIG. 2, the credentials 242 of FIG. 2, the hostname 244 of FIG. 2, and/or the environment name 246 of FIG. 2, to the health comparator 440.

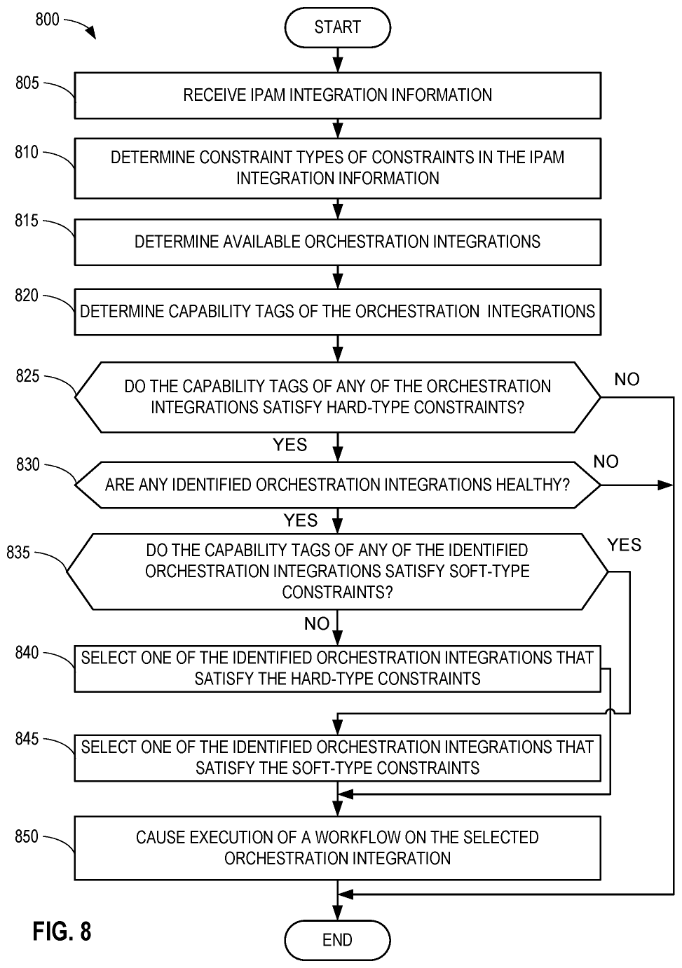

In some examples, the integration information manager circuitry 410 is instantiated by processor circuitry executing integration information manager instructions and/or configured to perform operations such as those represented by the flowchart of FIG. 8.

The example availability manager 420 determines available orchestration integrations (e.g., the orchestration integrations 248 and 268 of FIG. 2). In some examples, the availability manager 420 requests availability from servers (e.g., the servers 216 and 218 of FIG. 2) configured to host orchestration integrations. The example availability manager 420 identifies available ones of the orchestration integrations after receiving a response from orchestration integrations. The example availability manager 420 determines capability tags (e.g., the capability tags 256 and 272 of FIG. 2) of the available orchestration integrations. In some examples, servers hosting the orchestration integrations provide capability tags 256, 272 after the request for availability from the availability manager 420. The example availability manager 420 supplies the capability tags 256, 272 to the comparators 430-450. In some examples, the availability manager circuitry 420 is instantiated by processor circuitry executing availability manager instructions and/or configured to perform operations such as those represented by the flowchart of FIG. 8.

The example hard-type comparator 430 receives the hard-type constraints of the integration information from the integration information manager 410. The example hard-type comparator 430 receives the capability tags 256, 272 of available orchestration integrations from the availability manager 420. The example hard-type comparator 430 compares the hard-type constraints and the capability tags 256, 272. The example hard-type comparator 430 supplies identifications of the available orchestration integrations that satisfy the hard-type constraints to the health comparator 440. In some examples, the hard-type comparator circuitry 430 is instantiated by processor circuitry executing hard-type comparator instructions and/or configured to perform operations such as those represented by the flowchart of FIG. 8.

The example health comparator 440 receives the management system specific information from the integration information manager 410. The example health comparator 440 receives the capability tags 256, 272 from the availability manager 420. The example health comparator 440 receives identifications of the available orchestration integration that satisfy the hard-type constraints from the hard-type comparator 430. The example health comparator 440 compares the capability tags 256, 272 of the orchestration integrations identified by the hard-type comparator 430 to the management system specific information. The example health comparator 440 determines an orchestration integration to be healthy when the capability tags indicate that the orchestration integration includes IPAM workflows (e.g., the IPAM workflows 258 and 260 of FIG. 2) that support the management system specified by the IPAM integration 236.

The example health comparator 440 determines an orchestration integration to be unhealthy when the capability tags 256, 272 indicate that the orchestration integration does not include IPAM workflows that support the management system specified by the IPAM integration 236. The example health comparator 440 supplies identifications of the available orchestration integrations that satisfy the hard-type constraints and are healthy to the soft-type comparator 450. In some examples, the health comparator circuitry 440 is instantiated by processor circuitry executing health comparator instructions and/or configured to perform operations such as those represented by the flowchart of FIG. 8.

The example soft-type comparator 450 receives the soft-type constraints of the integration information from the integration information manager 410. The example soft-type comparator 450 receives the capability tags 256, 272 of available orchestration integrations from the availability manager 420. The example soft-type comparator 450 receives identifications of the available orchestration integration that satisfy the hard-type constraints and are healthy from the health comparator 440.

The example soft-type comparator 450 compares the soft-type constraints and the capability tags 256, 272. The example soft-type comparator 450 supplies identifications of the available orchestration integrations that satisfy the hard-type constraints, are health, and satisfy the soft-type constraints to the execution manager 460. Alternatively, the example soft-type comparator 450 supplies identifications of the available orchestration integrations that satisfy the hard-type constraints and are healthy to the execution manager 460 when none of the healthy available orchestration integrations satisfy the soft-type constraints. In some examples, the soft-type comparator circuitry 450 is instantiated by processor circuitry executing soft-type comparator instructions and/or configured to perform operations such as those represented by the flowchart of FIG. 8.

The example execution manager 460 receives identifications of the available orchestration integrations that at least satisfy the hard-type constraints from one of the comparators 430-450. In some examples, the execution manager 460 receives the available orchestration integrations that satisfy the hard-type constraints when the health comparator 440 determines all of the orchestration integrations are unhealthy. In other examples, the execution manager 460 receives the available orchestration integrations that satisfy the hard-type constraints and are healthy when the soft-type comparator 450 determines none of the orchestration integrations satisfy the soft-type constraints.

The example execution manager 460 selects one of the orchestration integrations from the one of the comparators 430-450 based on capability tags 256, 272. The example execution manager 460 generates execution information using the integration information from the integration information manager 410. The execution information is generated to cause the selected orchestration integration to perform an orchestration workflow. In some examples, the execution information identifies an IPAM workflow. In such examples, the IPAM workflow causes one of the management systems 204-208 to perform an operation specified in the execution information. For example, the execution information may cause the first orchestration integration 248 to use the first management system 204 to allocate an IP address. In some examples, the execution manager circuitry 460 is instantiated by processor circuitry executing execution manager instructions and/or configured to perform operations such as those represented by the flowchart of FIG. 8.

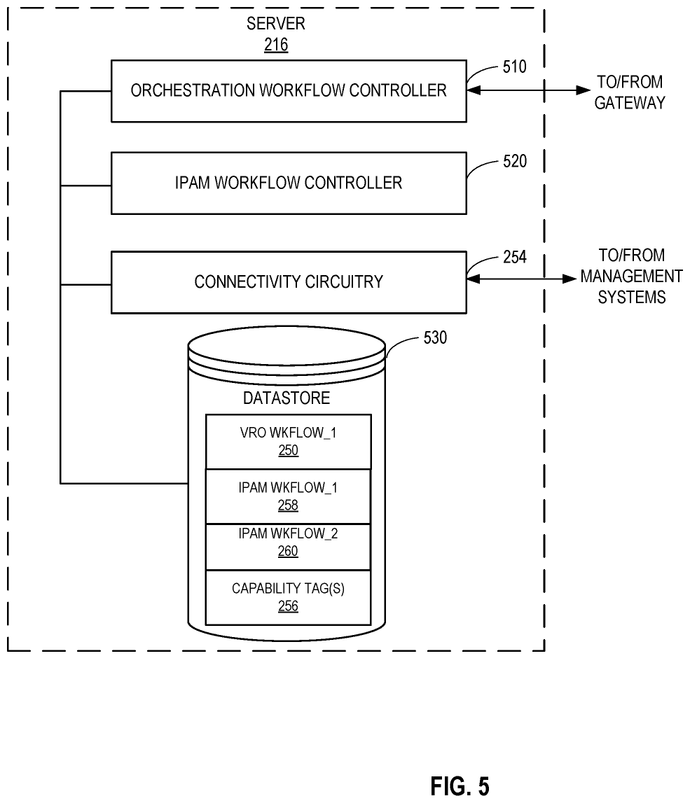

FIG. 5 is a block diagram of the first example server 216 to use one of the management systems 204-208 of FIG. 2 to perform orchestration operations of a deployment of the cloud application configuration 220 of FIG. 2. The first example server 216 of FIG. 5 may be instantiated (e.g., creating an instance of, bring into being for any length of time, materialize, implement, etc.) by processor circuitry such as a central processing unit executing instructions. Additionally or alternatively, the first example server 216 of FIG. 5 may be instantiated (e.g., creating an instance of, bring into being for any length of time, materialize, implement, etc.) by an ASIC or an FPGA structured to perform operations corresponding to the instructions. It should be understood that some or all of the first example server circuitry 216 of FIG. 5 may, thus, be instantiated at the same or different times. Some or all of the first example server circuitry 216 may be instantiated, for example, in one or more threads executing concurrently on hardware and/or in series on hardware. Moreover, in some examples, some or all of the first server circuitry 216 of FIG. 5 may be implemented by microprocessor circuitry executing instructions to implement one or more virtual machines and/or containers.

In the example of FIG. 5, the first server 216 includes the example connectivity circuitry 254 of FIG. 2, an example orchestration workflow controller 510, an example IPAM workflow controller 520, and an example datastore 530. In the example of FIG. 5, the datastore 530 includes the first orchestration workflow 250 of FIG. 2, the first capability tags 256 of FIG. 2, the first IPAM workflow 258 of FIG. 2, and the second IPAM workflow 260 of FIG. 2.

The example orchestration workflow controller 510 receives availability requests from the gateway 214 of FIG. 2. The example orchestration workflow controller 510 determines whether orchestration integrations of the first server 216 are available. In some examples, an orchestration integration is determined to be available when the orchestration workflow controller 510 is not performing operations of the workflows 250, 258, 260, and/or 270. The example orchestration workflow controller 510 supplies the capability tags 256 to the gateway 214 when the orchestration workflow controller 510 determines a corresponding orchestration integration is available.

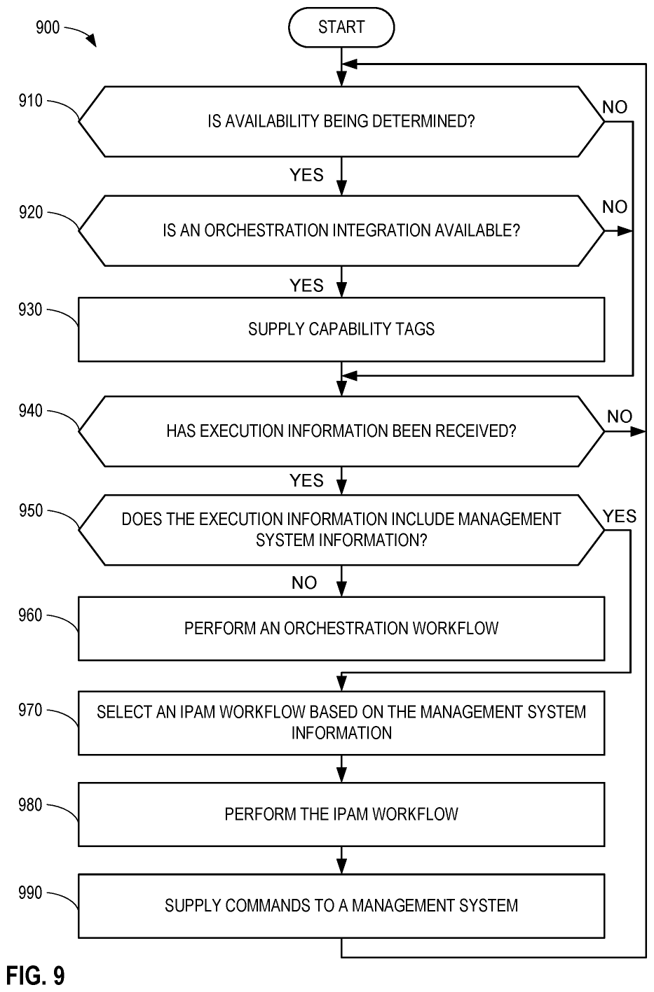

The example orchestration workflow controller 510 receives execution information from the gateway 214. The example orchestration workflow controller 510 selects one of the workflows 250, 258, 260 and/or 270 based on the execution information. In some examples, the orchestration workflow controller 510 causes the IPAM workflow controller 520 to perform operations of one of the IPAM workflows 258 and/or 260. In other examples, the orchestration workflow controller 510 performs operations of the first orchestration workflow 250. In some examples, the orchestration workflow controller circuitry 510 is instantiated by processor circuitry executing orchestration workflow controller instructions and/or configured to perform operations such as those represented by the flowchart of FIG. 9.

The example IPAM workflow controller 520 performs one of the IPAM workflows 258 or 260 based on the execution information supplied to the orchestration workflow controller 510. The one of the IPAM workflows 258 or 260 causes the IPAM workflow controller 520 to generate commands. The example IPAM workflow controller 520 supplies the commands to the connectivity circuitry 254 to cause one or more of the management systems 204-208 to perform a management operation, such as allocating an IP address, deallocating an IP address, get a range of IP addresses, etc. In some examples, the IPAM workflow controller circuitry 520 is instantiated by processor circuitry executing IPAM workflow controller instructions and/or configured to perform operations such as those represented by the flowchart of FIG. 9.

The example connectivity circuitry 254 supplies commands to the management systems 204-208.

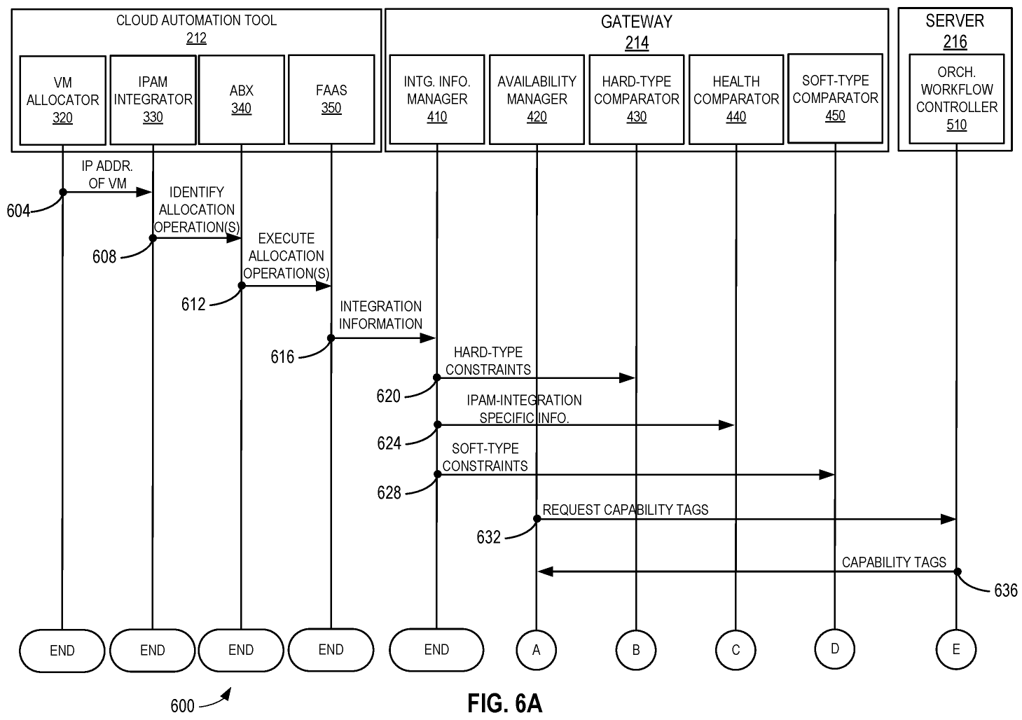

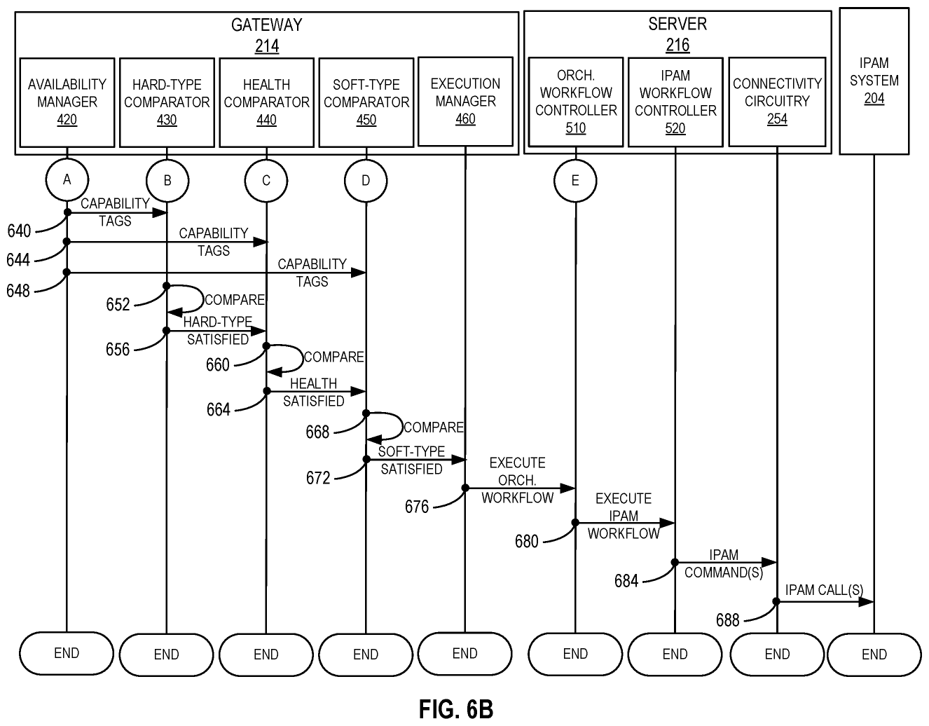

FIGS. 6A and 6B are a timing diagram of example operations 600 of the cloud automation tool 212 of FIGS. 2 and 3, the gateway 214 of FIGS. 2 and 4, and the first server 216 of FIGS. 2 and 5 to orchestrate internet protocol addresses management using one or more of the management systems 204-208 of FIG. 2. The operations 600 cause execution of an IPAM workflow (e.g., the IPAM workflows 258 and 260 of FIGS. 2 and 5) using the first orchestration integration 248 of FIGS. 2 and 5 on the first server 216.

At a first time 604, the VM allocator 320 of FIG. 3 supplies an IP address of a virtual machine (not illustrated) to the IPAM integrator 330 of FIG. 3. The virtual machine being one of the resources 222 of FIG. 2 that the cloud automation tool 212 manages. At the first time 604, the VM allocator 320 begins a process of allocating the IP address of the virtual machine. In some examples, the first time 604 occurs after the cloud automation tool 212 deploys the one of the resources 222 corresponding to the virtual machine. In other examples, the first time 604 occurs after deployment of any of the resources 222.

At a second time 608, the IPAM integrator 330 identifies allocation operations in the ABX operator 340 of FIG. 3. The allocation operations to cause allocation of the IP address from the first time 604. Unlike in FIG. 1, the allocation operations of FIG. 6 are determined based on the IPAM integration 236 of FIG. 2.

At a third time 612, the ABX operator 340 executes the allocation operations using the FaaS 350 of FIG. 3. In the example of FIG. 6, the allocation operations cause the FaaS 350 to generate integration information. In some examples, the integration information includes a combination of the first constraints 226 of FIGS. 2 and 3, from the cloud application configuration 220 of FIGS. 2 and 3, and the second constraints 238 of FIGS. 2 and 3, from the IPAM integration 236 of FIGS. 2 and 3. In such examples, the integration information further includes the provider name 240 of FIG. 2, the credentials 242 of FIG. 2, the hostname 244 of FIG. 2, and the environment name 246 of FIG. 2. The integration information may include the IP address of the virtual machine, from the first time 604.

At a fourth time 616, the FaaS 350 supplies the integration information to the integration information manager 410 of FIG. 4. After the fourth time 616, the integration information manager 410 begins to parse the integration information.

At a fifth time 620, the integration information manager 410 supplies hard-type constraints of the integration information, from the fourth time 616, to the hard-type comparator 430 of FIG. 4. In some examples, the integration information manager 410 supplies constraints (e.g., the constraints 226 and 238) that include a type identifier (e.g., the type identifiers 232 and/or 234) indicating a hard type to the hard-type comparator 430.

At a sixth time 624, the integration information manager 410 supplies information specific to the IPAM integration 236 of the integration information, from the fourth time 616, to the health comparator 440 of FIG. 4. In some examples, the IPAM integration 236 needs an IPAM plugin (e.g., the IPAM plugin 252 of FIG. 2) that includes a specific IPAM workflow (e.g., IPAM workflows 258 and 260 of FIG. 2). In such examples, the integration information manager 410 supplies information to identify an IPAM plugin capable of using a management system (e.g., the management systems 204-208 of FIG. 2) to the health comparator 440.

At a seventh time 628, the integration information manager 410 supplies soft-type constraints of the integration information, from the fourth time 616, to the soft-type comparator 450 of FIG. 4. In some examples, the integration information manager 410 supplies constraints (e.g., the constraints 226 and 238) that include a type identifier (e.g., the type identifier 232 and/or 234) indicating a soft type to the soft-type comparator 450.

At an eighth time 632, the availability manager 420 of FIG. 4 requests capability tags (e.g., the capability tags 256, 272 of FIG. 2) from orchestration workflow controllers (e.g., the orchestration workflow controller 510 of FIG. 5) that identify as an orchestration integration (e.g., the orchestration integrations 248 and 268 of FIG. 2) as available. In some examples, the availability manager 420 requests capability tags 256, 272 from a plurality of servers (e.g., the servers 216 and 218 of FIG. 2) that include one or more orchestration integrations.

At a ninth time 636, the orchestration workflow controller 510 supplies the first capability tags 256 to the availability manager 420. In some examples, at the ninth time 636 a plurality of servers (e.g., the servers 216 and 218) supply capability tags 256, 272 of a plurality of orchestration integrations (e.g., the orchestration integrations 248 and 268) to the availability manager 420. In such examples, an orchestration integration is considered available after supplying capability tags 256, 272 in response to the request from the eighth time 632.

Turning now to FIG. 6B, at a tenth time 640, the example availability manager 420 supplies the capability tags 256, from the ninth time 636, to the hard-type comparator 430. In some examples, the availability manager 420 supplies the capability tags based on the orchestration integration to the hard-type comparator 430. For example, the availability manager 420 supplies the first capability tags 256 to represent the first orchestration integration 248 and the second capability tags 272 to represent the second orchestration integration 268.

At an eleventh time 644, the example availability manager 420 supplies health capability tags, from the ninth time 636, to the health comparator 440. In some examples, the availability manager 420 supplies information identifying a type of and/or installation of the IPAM plugin of the available orchestration integrations.

At a twelfth time 648, the example availability manager 420 supplies the capability tags, from the ninth time 636, to the soft-type comparator 450.

At a thirteenth time 652, the example hard-type comparator 430 determines which of the available orchestration integrations, from the ninth time 636, have capability tags that satisfy the hard-type constraints, from the tenth time 640.

At a fourteenth time 656, the example hard-type comparator 430 supplies identifications of the available orchestration integrations that meet the hard-type constraints to the health comparator 440. In some examples, the hard-type comparator 430 reduces the available orchestration integrations to ones that include capability tags that satisfy the hard-type constraints.

At a fifteenth time 660, the example health comparator 440 determines whether the available orchestration integrations that meet the hard-type constraints are considered healthy. In some examples, the health comparator 440 determines an orchestration integration is healthy in response to the information, from the eleventh time 644, corresponds to a capable IPAM plugin. In such an example, the capable IPAM plugin is one that includes an IPAM workflow corresponding to the provider name 240 and/or version of the IPAM integration 236. In some examples, the example health comparator 440 considers an orchestration integration to be unhealthy when the IPAM plugin does not include capable IPAM workflows.

At a sixteenth time 664, the example health comparator 440 supplies identification of the available orchestration integrations that meet the hard-type constraints and are determined to be healthy to the soft-type comparator 450. In some examples, the health comparator 440 may supply the available orchestration integrations that meet the hard-type constraints to the execution manager 460 of FIG. 4, when all orchestration integrations are considered unhealthy.

At a seventeenth time 668, the example soft-type comparator 450 determines which of the available orchestration integrations, from the sixteenth time 664, have capability tags that satisfy the soft-type constraints, from the tenth time 640.

At an eighteenth time 672, the example soft-type comparator 450 supplies identifications of the available orchestration integrations that meet the soft-type constraints to the execution manager 460. In some examples, the soft-type comparator 450 reduces the available orchestration integrations to ones that include capability tags that satisfy both the hard-type and at least one of the soft-type constraints.

At a nineteenth time 676, the example execution manager 460 supplies execution information to the orchestration workflow controller 510 of FIG. 5 of the first server 216. In some examples, the execution manager 460 selects the first server 216 from the orchestration integrations identified at the eighteenth time 672.

At a twentieth time 680, the example orchestration workflow controller 510 causes execution of an IPAM workflow using the IPAM workflow controller 520 of FIG. 5.

At a twenty-first time 684, the example IPAM workflow controller 520 generates commands to cause the first management system 204 to allocate the IP address from the first time 604. At the twenty-first time 684, the IPAM workflow controller 520 supplies the commands to the connectivity circuitry 254 of FIGS. 2 and 5. In some examples, the IPAM workflow controller 520 supplies the commands to the connectivity circuitry 254 as they are generated. In other examples, the IPAM workflow controller 520 supplies the commands to the connectivity circuitry 254 after completing operations of an IPAM workflow.

At a twenty-second time 688, the connectivity circuitry 254 supplies the commands, from the twenty-first time 684, to the first management system 204. The commands to cause the first management system 204 to allocate the IP address from the first time 604.

While an example manner of implementing the cloud automation tool 212 of FIG. 2 is illustrated in FIG. 3, an example manner of implementing the gateway 214 of FIG. 2 is illustrated in FIG. 4, and an example manner of implementing the first server 216 of FIG. 2 is illustrated in FIG. 5, one or more of the elements, processes, and/or devices illustrated in FIGS. 3-5 may be combined, divided, re-arranged, omitted, eliminated, and/or implemented in any other way. Further, the example blueprint controller 310, the example VM allocator 320, the example IPAM integrator 330, the example ABX operator 340, the example FaaS 350, and/or, more generally, the example cloud automation tool 212 of FIG. 2; the example integration information manager 410, the example availability manager 420, the example hard-type comparator 430, the example health comparator 440, the example soft-type comparator 450, the example execution manager 460, and/or, more generally, the example gateway 214 of FIG. 2; and/or the example orchestration workflow controller 510, the example IPAM workflow controller 520, and/or, more generally, the first example server 216 of FIG. 2 may be implemented by hardware alone or by hardware in combination with software and/or firmware. Thus, for example, any of the example blueprint controller 310, the example VM allocator 320, the example IPAM integrator 330, the example ABX operator 340, the example FaaS 350, and/or, more generally, the example cloud automation tool 212 of FIG. 2; the example integration information manager 410, the example availability manager 420, the example hard-type comparator 430, the example health comparator 440, the example soft-type comparator 450, the example execution manager 460, and/or, more generally, the example gateway 214 of FIG. 2; and/or the example orchestration workflow controller 510, the example IPAM workflow controller 520, and/or, more generally, the first example server 216 of FIG. 2 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example cloud automation tool 212 of FIG. 2, the example gateway 214 of FIG. 2, and/or the first example server 216 of FIG. 2 may include one or more elements, processes, and/or devices in addition to, or instead of, those illustrated in FIGS. 3-5, and/or may include more than one of any or all of the illustrated elements, processes and devices.

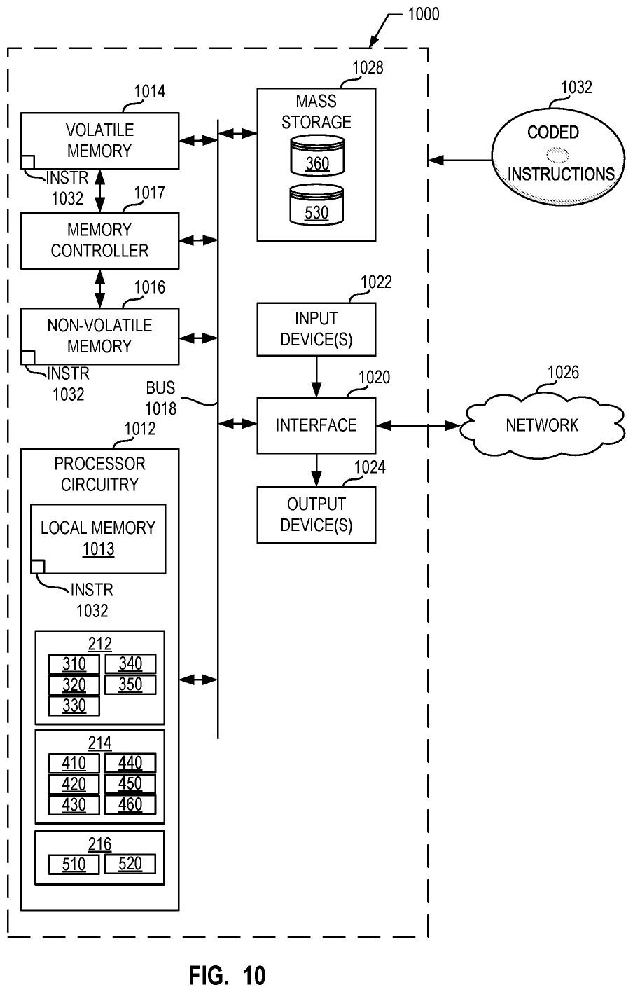

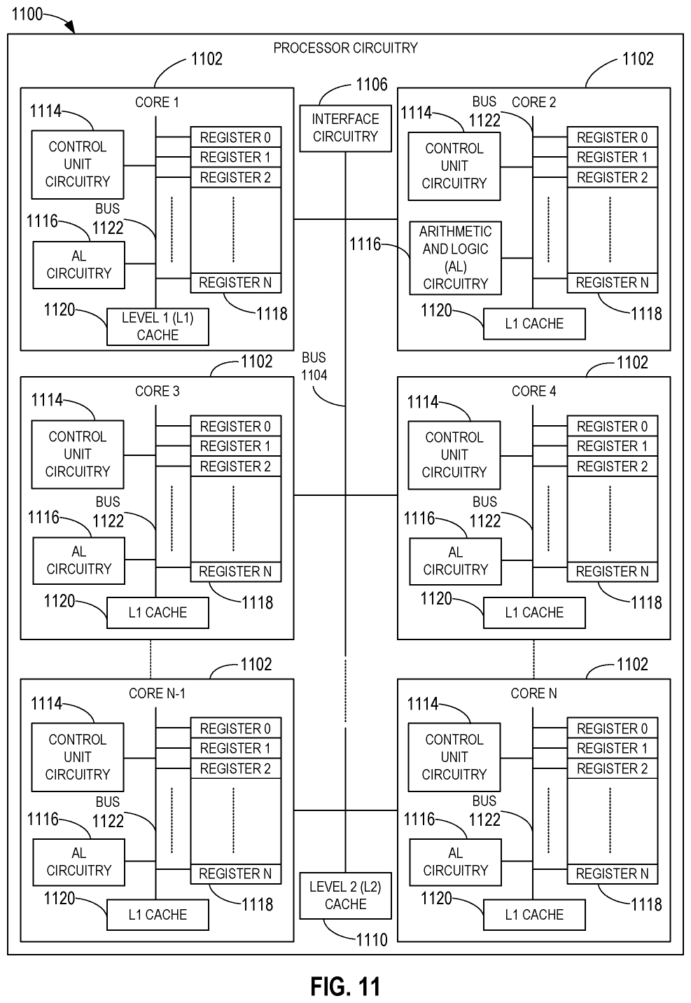

A flowchart representative of example machine-readable instructions, which may be executed to configure processor circuitry to implement the example cloud automation tool 212 of FIG. 3, is shown in FIG. 7. A flowchart representative of example machine-readable instructions, which may be executed to configure processor circuitry to implement the example gateway 214 of FIG. 4, is shown in FIG. 8. A flowchart representative of example machine-readable instructions, which may be executed to configure processor circuitry to implement the first example server 216 of FIG. 5, is shown in FIG. 9. The machine-readable instructions may be one or more executable programs or portion(s) of an executable program for execution by processor circuitry, such as the processor circuitry 1012 shown in the example processor platform 1000 discussed below in connection with FIG. 10 and/or the example processor circuitry discussed below in connection with FIGS. 11 and/or 12. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 7-9, many other methods of implementing the example cloud automation tool 212, the example gateway 214, and/or the first example server 216 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-9 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine-readable medium, and non-transitory machine-readable storage medium are expressly defined to include any type of computer readable storage device and/or storage disk and to exclude propagating signals and to exclude transmission media. As used herein, the terms “computer readable storage device” and “machine-readable storage device” are defined to include any physical (mechanical and/or electrical) structure to store information, but to exclude propagating signals and to exclude transmission media. Examples of computer readable storage devices and machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine-readable instructions and/or example operations 700 that may be executed and/or instantiated by processor circuitry to implement the cloud automation tool 212 of FIGS. 2 and 3. The machine-readable instructions and/or the operations 700 of FIG. 7 begin at block 710, at which the example blueprint controller 310 of FIG. 3 receives a cloud application configuration (e.g., the cloud application configuration 220 of FIG. 2) for deployment. In some examples, the example blueprint tool 210 of FIG. 2 supplies the cloud application configuration to the blueprint controller 310. In such examples, the cloud application configuration is considered ready for deployment when the user client device 202 identifies, via the blueprint tool 210, the cloud application configuration is ready to be deployed.

The example VM allocator 320 of FIG. 3 allocates resources (e.g., the resources 222 of FIG. 2) of the cloud application configuration. (Block 720). In some examples, the VM allocator 320 partitions physical compute resources to deploy the resources 222 of the cloud application configuration 220 as a virtual computing service. In such examples, the physical compute resources are a portion of computing resources of one of local machine, a server, a server rack, a server farm, etc.

The example VM allocator 320 determines if any of the allocated resources need an IP address allocated. (Block 730). In some examples, the VM allocator 320 determines that virtual computing services created at Block 720 by default need IP addresses to be allocated. In other examples, the VM allocator 320 determines a resource needs an IP address allocated when the resource needs to be addressable by external systems. In yet other examples, the VM allocator 320 determines a resource needs an IP address allocated by default.

If the example VM allocator 320 determines that none of the resources need an IP address allocated (e.g., Block 730: NO), control proceeds to end. If the example VM allocator 320 determines that at least one of the resources needs an IP address allocated (e.g., Block 730: YES), control proceeds to Block 740.

The example IPAM integrator 330 of FIG. 3 determines constraints of the cloud application configuration (e.g., the first constraints 226 of FIG. 2). (Block 740). In some examples, the IPAM integrator 330 adds the constraints and corresponding constraint type identifiers (e.g., the type identifiers 232 and 234 of FIG. 2) to IPAM integration information.

The example IPAM integrator 330 determines constraints of an IPAM integration (e.g., the second constraints 238 of FIG. 2). (Block 750). In some examples, the IPAM integrator 330 adds the constraints and corresponding constraint types to IPAM integration information.

The example FaaS 350 of FIG. 3 supplies IPAM integration information including the constraints to a gateway (e.g., the gateway 214 of FIGS. 2 and 4). (Block 760). In some examples, the ABX operator 340 of FIG. 3 provides the FaaS 350 with the constraints, from Blocks 740 and 750, and additional information corresponding to the IPAM integration. In such examples, the ABX operator 340 may identify the provider name 240 of FIG. 2, the credentials 242 of FIG. 2, the hostname 244 of FIG. 2, and/or the environment name 246 of FIG. 2 of the IPAM integration 236 of FIG. 2. The example instructions of FIG. 7 end.

Although example processes are described with reference to the flowchart illustrated in FIG. 7, many other methods of implementing the cloud automation tool 212 may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

FIG. 8 is a flowchart representative of example machine-readable instructions and/or example operations that may be executed and/or instantiated by example processor circuitry to implement the gateway 214 of FIGS. 2 and 4. The machine-readable instructions and/or the operations 800 of FIG. 8 begin at block 805, at which the example integration information manager 410 of FIGS. 4 and 6A receives IPAM integration information. In some examples, the integration information manager 410 receives the IPAM integration information from the cloud automation tool 212 of FIGS. 2, 3, 6A, and 6B. In such examples, the integration information manager 410 receives the IPAM integration information after performance of Block 760 of FIG. 7.

The example integration information manager 410 determines constraint types (e.g., the type identifiers 232 and 234 of FIG. 2) of constraints in the IPAM integration information (e.g., the constraints 226 and 238 of FIG. 2). (Block 810). In some examples, the integration information manager 410 supplies the constraints that correspond to hard-type identifiers to the hard-type comparator 430 of FIG. 4. In such examples, the integration information manager 410 supplies constraints that correspond to the IPAM integration 236 of FIG. 2 to the health comparator 440 of FIG. 4. In such examples, the integration information manager 410 supplies the constraints that correspond to soft-type identifiers to the soft-type comparator 450 of FIG. 4. For example, operations that occur at the times 620-628 of FIG. 6A.

The example availability manager 420 of FIGS. 4, 6A, and 6B determines available orchestration integrations (e.g., the orchestration integrations 248 and 268 of FIG. 2). (Block 815). In some examples, the availability manager 420 determines available orchestration integrations by requesting availability from a plurality of servers (e.g., the servers 216 and 218). In such examples, the availability manager 420 determines an orchestration integration is available when the orchestration integration supplies capability tags (e.g., the capability tags 256 and 272 of FIG. 2) in response to the request. For example, operations that occur at the times 632 and 636 of FIG. 6A. Alternatively, the availability manager 420 may use, in accordance with teachings disclosed herein, an alternative method of determining available orchestration integrations. Such as, tracking and/or monitoring activities of orchestration integrations.

The example availability manager 420 determines capability tags (e.g., the capability tags 256 and 272) of the orchestration integrations. (Block 820). The example availability manager 420 may determine the capability tags of the orchestration integrations in response to requesting availability of orchestration integrations at Block 810. In some examples, the availability manager 420 supplies the capability tags of the orchestration integrations to the comparators 430-450. In such examples, the availability manager 420 may supply the capability tags and information identifying a corresponding orchestration integration. For example, operations that occur at the times 640-648 of FIG. 6B.

The example hard-type comparator 430 determines if the capability tags of any of the orchestration integrations satisfy hard-type constraints. (Block 825). In some examples, the hard-type comparator 430 compares capability tags of each available orchestration integration to the hard-type constraints (e.g., hard-type constraints determined at Block 810) from the IPAM integration information. In such examples, the hard-type comparator 430 supplies the health comparator 440 with indications of the orchestration integrations that meet hard-type constraints. For example, operations that occur at the times 652 and 656 of FIG. 6B.

If the example hard-type comparator 430 determines none of the orchestration integrations have capability tags that satisfy the hard-type constraints (e.g., Block 825: NO), control proceeds to end. If the example hard-type comparator 430 determines at least one of the orchestration integrations have capability tags that satisfy the hard-type constraints (e.g., Block 825: YES), control proceeds to Block 830.

The example health comparator 440 determines if any identified orchestration integrations are healthy. (Block 830). In some examples, the health comparator 440 compares the constraints that correspond to the IPAM integration 236, from Block 810, to health capability tags of the orchestration integrations identified by the hard-type comparator 430 at Block 825. In such examples, the health comparator 440 supplies the soft-type comparator 450 with indications of the orchestration integrations that are healthy and meet hard-type constraints. For example, operations that occur at the times 660 and 664 of FIG. 6B.

If the example health comparator 440 determines none of the orchestration integrations are healthy (e.g., Block 830: NO), control proceeds to end. If the example health comparator 440 determines at least one of the orchestration integrations is healthy (e.g., Block 830: YES), control proceeds to Block 835.

The example soft-type comparator 450 determines if the capability tags of any of the orchestration integrations satisfy soft-type constraints. (Block 835). In some examples, the soft-type comparator 450 compares capability tags of each available orchestration integration (e.g., the orchestration integration identified as healthy at Block 830) to the soft-type constraints determined at Block 810 from the IPAM integration information. In such examples, the soft-type comparator 450 supplies the execution manager 460 of FIGS. 4 and 6B with indications of the orchestration integrations that satisfy hard-type constraints, are healthy, and satisfy soft-type constraints. For example, operations that occur at the times 668 and 672 of FIG. 6B.

If the example soft-type comparator 450 determines none of the orchestration integrations have capability tags that satisfy the soft-type constraints (e.g., Block 835: NO), the example execution manager 460 selects one of the identified orchestration integrations that satisfy the hard-type constraints. (Block 840). In some examples, the execution manager 460 receives indications of orchestration integrations that satisfy hard-type constraints (e.g., the orchestration integrations identified at Block 825) from the soft-type comparator 450 following a determination that the orchestration integrations do not satisfy the soft-type constraints. In other examples, the execution manager 460 receives indications of orchestration integrations that satisfy hard-type constraints from the hard-type comparator 430. In such an example, the execution manager 460 uses the orchestration integrations, from Block 825, after Block 835 returns a result of NO.

If the example soft-type comparator 450 determines at least one of the orchestration integrations has capability tags that satisfy the soft-type constraints (e.g., Block 835: YES), the example execution manager 460 selects one of the identified orchestration integrations that satisfies the soft-type constraints. (Block 840).

The example execution manager 460 causes execution of a workflow on the selected orchestration integration. (Block 850). In some examples, the execution manager 460 causes the selected orchestration integration (e.g., selected at Block 840 or Block 850) to perform an orchestration workflow (e.g., the orchestration workflows 250 and 270 of FIG. 2). In such examples, the execution manager 460 supplies execution information to a server corresponding to the selected orchestration integration. The execution information may include IPAM integration information, which identifies one of the management systems 204-208 of FIG. 2 and an IP address to allocate. The example instructions end.

Although example processes are described with reference to the flowchart illustrated in FIG. 8, many other methods of implementing the gateway 214 may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

FIG. 9 is a flowchart representative of example machine-readable instructions and/or example operations that may be executed and/or instantiated by example processor circuitry to implement the first server 216 of FIGS. 2 and 5. The machine-readable instructions and/or the operations 900 of FIG. 9 begin at block 910, at which the example orchestration workflow controller 510 of FIG. 5 determines if availability is being determined. In some examples, the orchestration workflow controller 510 receives a request for availability from the gateway 214 of FIGS. 2, 4, 6A, and 6B.

If the example orchestration workflow controller 510 determines that availability is not being determined (e.g., Block 910: NO), control proceeds to Block 940. If the example orchestration workflow controller 510 determines that availability is being determined (e.g., Block 910: YES), the orchestration workflow controller 510 determines if an orchestration integration is available. (Block 920). In some examples, the orchestration workflow controller 510 determines an orchestration integration is available when an orchestration workflow (e.g., 250 and 270 of FIG. 2) is not being performed. In such examples, the orchestration workflow controller 510 determines an orchestration integration is not available when an orchestration workflow is being performed.

The example orchestration workflow controller 510 supplies capability tags (e.g., the capability tags 256 and 272 of FIG. 2) to the gateway 214. (Block 930). In some examples, the orchestration workflow controller 510 supplies the capability tags that are defined when an orchestration integration was created on the first server 216. In other examples, the orchestration workflow controller 510 determines the capability tags based on properties of the orchestration integration.

The example orchestration workflow controller 510 determines if execution information has been received from the gateway 214. (Block 940). In some examples, the gateway 214 supplies execution information to the orchestration workflow controller 510 to begin execution of an orchestration workflow. If the example orchestration workflow controller 510 determines that execution information has not been received (e.g., Block 940: NO), control returns to Block 910.

If the example orchestration workflow controller 510 determines that execution information has been received (e.g., Block 940: YES), the orchestration workflow controller 510 determines if the execution information includes management system information (e.g., the provider name 240 of FIG. 2, the credentials 242 of FIG. 2, and/or the hostname 244 of FIG. 2). (Block 950). In some examples, the management system information identifies an account of the user client device 202 of FIG. 2 in one of the management systems 204-208 of FIG. 2. In such examples, the execution information may include information specific to an operation to be performed using the one of the management systems 204-208. For example, the execution information may include an IP address to be allocated by the one of the management systems 204-208.

If the example orchestration workflow controller 510 determines that the execution information does not include management system information (e.g., Block 950: NO), the orchestration workflow controller 510 performs an orchestration workflow. (Block 960). In some examples, the execution information identifies the orchestration workflow to be performed by the orchestration workflow controller 510.

If the orchestration workflow controller 510 determines that the execution information does include management system information (e.g., Block 950: YES), the example IPAM workflow controller 520 of FIGS. 5 and 6B selects an IPAM workflow (e.g., the IPAM workflows 258 and 260 of FIG. 2) based on the management system information. (Block 970). In some examples, the IPAM workflow controller 520 selects the IPAM workflow based on the provider name 240, the credentials 242, and/or the hostname 244. In such examples, the IPAM workflow controller 520 further considers an operation to be performed using one of the management systems 204-208. For example, the IPAM workflow controller 520 selects an IPAM workflow to generate commands to allocate an IP address. In such an example, the commands are specific to one of the management systems 204-208.

The example IPAM workflow controller 520 performs the IPAM workflow. (Block 980). In some examples, the IPAM workflow controller 520 performs operations of the IPAM workflow (e.g., an IPAM workflow selected at Block 970) to generate one or more commands to cause performance of operations in one of the management systems 204-208.

The example connectivity circuitry 254 of FIGS. 2 and 5 supplies commands to a management system. (Block 990). In some examples, the connectivity circuitry 254 supplies commands generated as a result of performance of the IPAM workflow, from Block 980. In such examples, the commands cause the management system to perform management operations, such as allocating an IP address, deallocating an IP address, get IP range, etc. Control returns to Block 910. Alternatively, the example instructions of FIG. 9 end after the first server 216 receives a command to release compute resources of the first orchestration integration 248.

Although example processes are described with reference to the flowchart illustrated in FIG. 9, many other methods of implementing the first server 216 may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

FIG. 10 is a block diagram of an example processor platform 1000 structured to execute and/or instantiate the machine-readable instructions and/or the operations of FIGS. 7-9 to implement the cloud automation tool 212 of FIGS. 2 and 3, the gateway 214 of FIGS. 2 and 4, and/or the first server 216 of FIGS. 2 and 5. The processor platform 1000 can be, for example, a server, a personal computer, a workstation, a self-learning machine (e.g., a neural network), a personal digital assistant (PDA), an Internet appliance, a gaming console, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs, microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example blueprint controller 310, the example VM allocator 320, the example IPAM integrator 330, the example ABX operator 340, the example FaaS 350, and/or, more generally, the example cloud automation tool 212 of FIG. 2; the example integration information manager 410, the example availability manager 420, the example hard-type comparator 430, the example health comparator 440, the example soft-type comparator 450, the example execution manager 460, and/or, more generally, the example gateway 214 of FIG. 2; and/or the example orchestration workflow controller 510, the example IPAM workflow controller 520, and/or, more generally, the first example server 216 of FIG. 2.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine-readable instructions 1032, which may be implemented by the machine-readable instructions of FIGS. 7-9, may be stored in the mass storage device 1028, in the volatile memory 1014, in the non-volatile memory 1016, and/or on a removable non-transitory computer readable storage medium such as a CD or DVD.

FIG. 11 is a block diagram of an example implementation of the processor circuitry 1012 of FIG. 10. In this example, the processor circuitry 1012 of FIG. 10 is implemented by a microprocessor 1100. For example, the microprocessor 1100 may be a general-purpose microprocessor (e.g., general purpose microprocessor circuitry). The microprocessor 1100 executes some or all of the machine-readable instructions of the flowcharts of FIGS. 7-9 to effectively instantiate the circuitry of FIGS. 3-5 as logic circuits to perform the operations corresponding to those machine-readable instructions. In some such examples, the circuitry of FIGS. 3-5 is instantiated by the hardware circuits of the microprocessor 1100 in combination with the instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine-readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine-readable instructions and/or operations represented by the flowcharts of FIGS. 7-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 1012 of FIG. 10. In this example, the processor circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the microprocessor 1100 of FIG. 11 described above (which is a general purpose device that may be programmed to execute some or all of the machine-readable instructions represented by the flowcharts of FIGS. 7-9 but whose interconnections and logic circuitry are fixed once fabricated), the FPGA circuitry 1200 of the example of FIG. 6 includes interconnections and logic circuitry that may be configured and/or interconnected in different ways after fabrication to instantiate, for example, some or all of the machine-readable instructions represented by the flowcharts of FIGS. 7-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of FIGS. 7-9. As such, the FPGA circuitry 1200 may be structured to effectively instantiate some or all of the machine-readable instructions of the flowcharts of FIGS. 7-9 as dedicated logic circuits to perform the operations corresponding to those software instructions in a dedicated manner analogous to an ASIC. Therefore, the FPGA circuitry 1200 may perform the operations corresponding to the some or all of the machine-readable instructions of FIGS. 7-9 faster than the general-purpose microprocessor can execute the same.

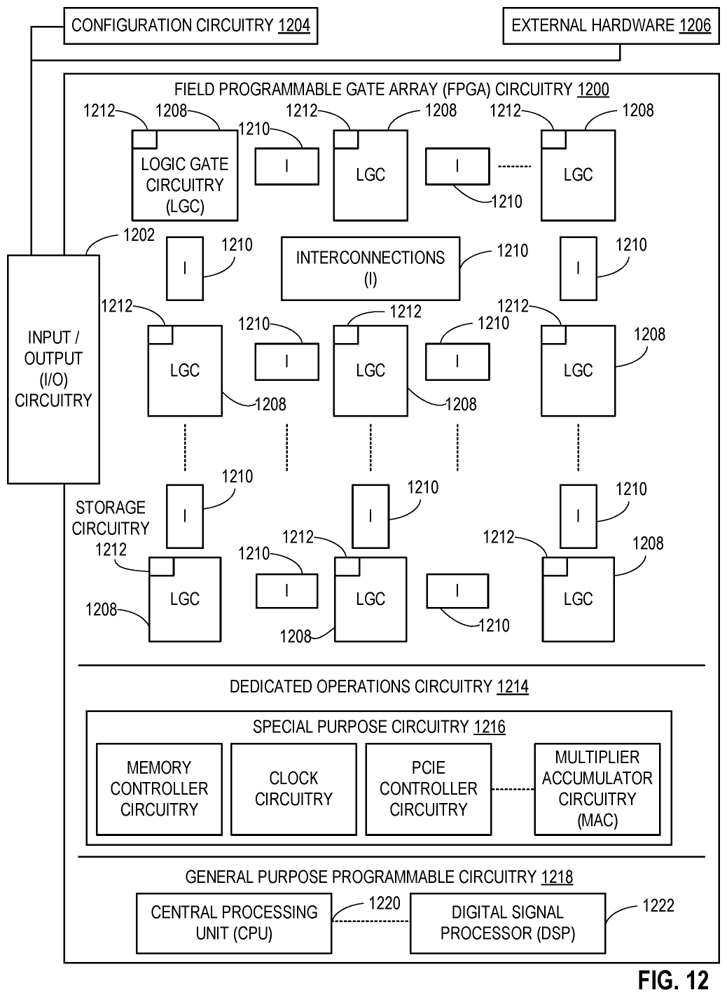

In the example of FIG. 12, the FPGA circuitry 1200 is structured to be programmed (and/or reprogrammed one or more times) by an end user by a hardware description language (HDL) such as Verilog. The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain machine-readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may be implemented by external hardware circuitry. For example, the external hardware 1206 may be implemented by the microprocessor 1100 of FIG. 11. The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations that may correspond to at least some of the machine-readable instructions of FIGS. 7-9 and/or other desired operations. The logic gate circuitry 1208 shown in FIG. 12 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 6 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the processor circuitry 1012 of FIG. 10, many other approaches are contemplated. For example, as mentioned above, modern FPGA circuitry may include an on-board CPU, such as one or more of the example CPU 1220 of FIG. 12. Therefore, the processor circuitry 1012 of FIG. 10 may additionally be implemented by combining the example microprocessor 1100 of FIG. 11 and the example FPGA circuitry 1200 of FIG. 12. In some such hybrid examples, a first portion of the machine-readable instructions represented by the flowcharts of FIGS. 7-9 may be executed by one or more of the cores 1102 of FIG. 11, a second portion of the machine-readable instructions represented by the flowcharts of FIGS. 7-9 may be executed by the FPGA circuitry 1200 of FIG. 12, and/or a third portion of the machine-readable instructions represented by the flowcharts of FIGS. 7-9 may be executed by an ASIC. It should be understood that some or all of the circuitry of FIGS. 3-5 may, thus, be instantiated at the same or different times. Some or all of the circuitry may be instantiated, for example, in one or more threads executing concurrently and/or in series. Moreover, in some examples, some or all of the circuitry of FIGS. 3-5 may be implemented within one or more virtual machines and/or containers executing on the microprocessor.

In some examples, the processor circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the processor circuitry 1012 of FIG. 10, which may be in one or more packages. For example, the XPU may include a CPU in one package, a DSP in another package, a GPU in yet another package, and an FPGA in still yet another package.

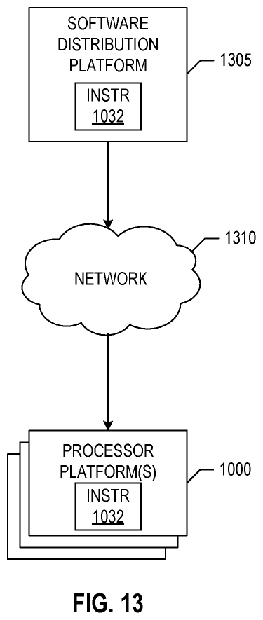

A block diagram illustrating an example software distribution platform 1305 to distribute software such as the example machine-readable instructions 1132 of FIG. 11 to hardware devices owned and/or operated by third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine-readable instructions 1132 of FIG. 11. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1132, which may correspond to the example machine-readable instructions of FIGS. 7-9, as described above. The one or more servers of the example software distribution platform 1305 are in communication with an example network 1310, which may correspond to any one or more of the Internet and/or any of the example networks 1310 described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1132 from the software distribution platform 1305. For example, the software, which may correspond to the example machine-readable instructions 1132 of FIG. 13, may be downloaded to the example processor platform 1000, which is to execute the machine-readable instructions 1132. In some examples, one or more servers of the software distribution platform 1305 periodically offer, transmit, and/or force updates to the software (e.g., the example machine-readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that orchestrate internet protocol address management. Disclosed systems, methods, apparatus, and articles of manufacture improve the efficiency of using a computing device by orchestrating internet protocol address management using a management system. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

Example methods, apparatus, systems, and articles of manufacture to orchestrate internet protocol address management are disclosed herein. Further examples and combinations thereof include the following.

Example 1 includes a system to orchestrate internet protocol address management, the system comprising at least one memory, programmable circuitry, and machine-readable instructions to program the programmable circuitry to select an orchestration integration based on capability tags of a plurality of orchestration integrations and based on constraints of an internet protocol address management (IPAM) integration, and cause execution of a workflow using the orchestration integration, the workflow to cause an IPAM system to allocate an internet protocol address for a resource of a cloud application.

Example 2 includes the system of example 1, wherein the programmable circuitry is to determine available ones of the orchestration integrations by determining which of the orchestration integrations include an IPAM plugin, the IPAM plugin including an IPAM workflow, and Select the orchestration integration from the available ones of the orchestration integrations.

Example 3 includes the system of example 1, wherein the capability tags include at least one of an environment tag, a network tag, or a health tag for ones of the plurality of orchestration integrations.

Example 4 includes the system of example 1, wherein the programmable circuitry is to determine types of the constraints, the types including a hard type and a soft type, the hard type identifies a constraint as needed, the soft type identifies the constraint as preferred.

Example 5 includes the system of example 1, wherein the programmable circuitry is to compare the capability tags of ones of the orchestration integrations to the constraints to select the orchestration integration.

Example 6 includes the system of example 1, wherein the orchestration integration is a first orchestration integration, the programmable circuitry is to select a second orchestration integration from the orchestration integrations after a determination that the first orchestration integration is not healthy.

Example 7 includes the system of example 1, wherein the programmable circuitry is to select the workflow from a plurality of workflows based on a management service identified by the IPAM integration.

Example 8 includes a non-transitory machine-readable storage medium comprising instructions that, when executed, cause programmable circuitry to at least select an orchestration integration based on capability tags of a plurality of orchestration integrations and based on constraints of an internet protocol address management (IPAM) integration, and cause execution of a workflow using the orchestration integration, the workflow to cause an IPAM system to allocate an internet protocol address for a resource of a cloud application.

Example 9 includes the at least one non-transitory computer readable storage medium of example 8, wherein the instructions are to cause the programmable circuitry to determine available ones of the orchestration integrations by determining which of the orchestration integrations include an IPAM plugin, the IPAM plugin including an IPAM workflow, and select the orchestration integration from the available ones of the orchestration integrations.

Example 10 includes the at least one non-transitory computer readable storage medium of example 8, wherein the capability tags include at least one of an environment tag, a network tag, or a health tag for ones of the orchestration integrations.

Example 11 includes the at least one non-transitory computer readable storage medium of example 8, wherein the instructions are to cause the programmable circuitry to determine types of the constraints, the types including a hard type and a soft type, the hard type identifies a constraint as needed, the soft type identifies the constraint as preferred.

Example 12 includes the at least one non-transitory computer readable storage medium of example 8, wherein the instructions are to cause the programmable circuitry to compare the capability tags of ones of the orchestration integrations to the constraints to select the orchestration integration.

Example 13 includes the at least one non-transitory computer readable storage medium of example 8, wherein the orchestration integration is a first orchestration integration, and the instructions are to cause the programmable circuitry to select a second orchestration integration from the orchestration integrations after a determination that the first orchestration integration is not healthy.

Example 14 includes the at least one non-transitory computer readable storage medium of example 8, wherein the instructions are to cause the programmable circuitry to select the workflow from a plurality of workflows based on a management service identified by the IPAM integration.

Example 15 includes a method comprising selecting, by a gateway, an orchestration integration based on capability tags of a plurality of orchestration integrations and based on constraints of an internet protocol address management (IPAM) integration, and causing, by the gateway, execution of a workflow using the orchestration integration, the workflow to cause an IPAM system to allocate an internet protocol address for a resource of a cloud application.

Example 16 includes the method of example 15, further including determining available ones of the orchestration integrations by determining which of the orchestration integrations include an IPAM plugin, the IPAM plugin including an IPAM workflow, and selecting the orchestration integration from the available ones of the orchestration integrations.

Example 17 includes the method of example 15, wherein the capability tags include at least one of an environment tag, a network tag, or a health tag for ones of the plurality of orchestration integrations.

Example 18 includes the method of example 15, further including determining types of the constraints, the types including a hard type and a soft type, the hard type identifies a constraint as needed, the soft type identifies the constraint as preferred.

Example 19 includes the method of example 15, further including comparing the capability tags of ones of the orchestration integrations to the constraints to select the orchestration integration.

Example 20 includes the method of example 15, wherein the orchestration integration is a first orchestration integration, further including selecting a second orchestration integration from the orchestration integrations after to a determination that the first orchestration integration is not healthy.

Example 21 includes the method of example 15, further including selecting the workflow from a plurality of workflows based on a management service identified by the IPAM integration.

1. A system to orchestrate internet protocol address management, the system comprising:
at least one memory;
programmable circuitry; and
machine-readable instructions to program the programmable circuitry to:
select an orchestration integration based on capability tags of a plurality of orchestration integrations and based on constraints of an internet protocol address management (IPAM) integration, wherein the capability tags comprise a first capability tag, the first capability tag represents properties of one of the plurality of orchestration integration, and the first capability tag comprises at least one of an environment tag, a network tag, or a health tag; and
cause execution of a workflow using the orchestration integration, the workflow to cause an IPAM system to allocate an internet protocol address for a resource of a cloud application.

2. The system of claim 1, wherein the programmable circuitry is to:
determine available ones of the orchestration integrations by determining which of the orchestration integrations include an IPAM plugin, the IPAM plugin including an IPAM workflow; and
Select the orchestration integration from the available ones of the orchestration integrations.

3. (canceled)

4. The system of claim 1, wherein the programmable circuitry is to determine types of the constraints, the types including a hard type and a soft type, the hard type identifies a constraint as needed, the soft type identifies the constraint as preferred.

5. The system of claim 1, wherein the programmable circuitry is to compare the capability tags of ones of the orchestration integrations to the constraints to select the orchestration integration.

6. The system of claim 1, wherein the orchestration integration is a first orchestration integration, the programmable circuitry is to select a second orchestration integration from the orchestration integrations after a determination that the first orchestration integration is not healthy.

7. The system of claim 1, wherein the programmable circuitry is to select the workflow from a plurality of workflows based on a management service identified by the IPAM integration.

8. A non-transitory machine-readable storage medium comprising instructions that, when executed, cause programmable circuitry to at least:
select an orchestration integration based on capability tags of a plurality of orchestration integrations and based on constraints of an internet protocol address management (IPAM) integration, wherein the capability tags comprise a first capability tag, the first capability tag represents properties of one of the plurality of orchestration integration, and the first capability tag comprises at least one of an environment tag, a network tag, or a health tag; and
cause execution of a workflow using the orchestration integration, the workflow to cause an IPAM system to allocate an internet protocol address for a resource of a cloud application.

9. The at least one non-transitory computer readable storage medium of claim 8, wherein the instructions are to cause the programmable circuitry to
determine available ones of the orchestration integrations by determining which of the orchestration integrations include an IPAM plugin, the IPAM plugin including an IPAM workflow; and
select the orchestration integration from the available ones of the orchestration integrations.

10. (canceled)

11. The at least one non-transitory computer readable storage medium of claim 8, wherein the instructions are to cause the programmable circuitry to determine types of the constraints, the types including a hard type and a soft type, the hard type identifies a constraint as needed, the soft type identifies the constraint as preferred.

12. The at least one non-transitory computer readable storage medium of claim 8, wherein the instructions are to cause the programmable circuitry to compare the capability tags of ones of the orchestration integrations to the constraints to select the orchestration integration.

13. The at least one non-transitory computer readable storage medium of claim 8, wherein the orchestration integration is a first orchestration integration, and the instructions are to cause the programmable circuitry to select a second orchestration integration from the orchestration integrations after a determination that the first orchestration integration is not healthy.

14. The at least one non-transitory computer readable storage medium of claim 8, wherein the instructions are to cause the programmable circuitry to select the workflow from a plurality of workflows based on a management service identified by the IPAM integration.

15. A method comprising:
selecting, by a gateway, an orchestration integration based on capability tags of a plurality of orchestration integrations and based on constraints of an internet protocol address management (IPAM) integration, wherein the capability tags comprise a first capability tag, the first capability tag represents properties of one of the plurality of orchestration integration, and the first capability tag comprises at least one of an environment tag, a network tag, or a health tag; and
causing, by the gateway, execution of a workflow using the orchestration integration, the workflow to cause an IPAM system to allocate an internet protocol address for a resource of a cloud application.

16. The method of claim 15, further including:
determining available ones of the orchestration integrations by determining which of the orchestration integrations include an IPAM plugin, the IPAM plugin including an IPAM workflow; and
selecting the orchestration integration from the available ones of the orchestration integrations.

17. (canceled)

18. The method of claim 15, further including determining types of the constraints, the types including a hard type and a soft type, the hard type identifies a constraint as needed, the soft type identifies the constraint as preferred.

19. The method of claim 15, further including comparing the capability tags of ones of the orchestration integrations to the constraints to select the orchestration integration.

20. The method of claim 15, wherein the orchestration integration is a first orchestration integration, further including selecting a second orchestration integration from the orchestration integrations after to a determination that the first orchestration integration is not healthy.

21. The method of claim 15, further including selecting the workflow from a plurality of workflows based on a management service identified by the IPAM integration.
